(19) United States
(12) Patent Application Publication
(10) Pub. No.: US 2025/0282231 A1
(43) Pub. Date: Sep. 11, 2025

(54) ELECTRIC VEHICLE CONTROL DEVICE

(71) Applicant: Hino Motors, Ltd., Hino-shi, Tokyo (JP)

(72) Inventors: Hirohisa KITAKAZE, Hino-shi (JP); Naoki UEDA, Hino-shi (JP)

(73) Assignee: Hino Motors, Ltd., Hino-shi, Tokyo (JP)

(21) Appl. No.: 18/859,346

(22) PCT Filed: Apr. 18, 2023
(86) PCT No.: PCT/JP2023/015462

§ 371 Date: Oct. 23, 2024

(30) Foreign Application Priority Data
Apr. 27, 2022 (JP) 2022-072923

(51) Int. Cl. B60L 15/20; B60L 7/10

(52) U.S. Cl. CPC B60L 15/20; B60L 7/10; B60L 2240/421; B60L 2240/423; B60L 2250/28

(57) ABSTRACT

An electric vehicle control device that controls acceleration/deceleration of an electric vehicle using a motor as a drive source. The electric vehicle control device includes an accelerator opening degree detection unit configured to detect an accelerator opening degree of the electric vehicle, a motor rotation speed detection unit configured to detect a motor rotation speed, and a motor control unit configured to control the motor, in which the motor control unit obtains a target torque based on the accelerator opening degree and the motor rotation speed, obtains a torque rate that is an amount of change in torque per unit time based on the accelerator opening degree, and controls the motor such that a torque of the motor becomes the target torque at the torque rate.

### TECHNICAL FIELD

The present disclosure relates to an electric vehicle control device that controls an electric vehicle using a motor as a drive source.

### BACKGROUND ART

In an electric vehicle using a motor as a drive source, a power running torque is generated by the motor to drive the electric vehicle, and a regenerative torque is generated by the motor to charge a battery (see, for example, Patent Literatures 1 and 2).

### CITATION LIST

### Patent Literature

Patent Literature 1: Japanese Patent No. 5302749
Patent Literature 2: Japanese Patent No. 6015312

### SUMMARY OF INVENTION

### Technical Problem

In a power running state in which the power running torque is generated by the motor, it is considered that a driver decreases an accelerator opening degree when the driver wants to slowly accelerate the electric vehicle and increases the accelerator opening degree when the driver wants to immediately accelerate the electric vehicle. In general, however, a torque rate of an instruction torque for controlling the motor is constant (see, for example, Patent Literature 1). Therefore, in the power running state, an intention of the driver based on the accelerator operation described above cannot be sufficiently reflected.

In addition, in a regenerative state in which the regenerative torque is generated by the motor, when the torque rate is the same as that in the power running state, the deceleration of the electric vehicle becomes sensitive and it becomes difficult for the driver to adjust to target deceleration. Moreover, the motor has characteristics of low rotation high torque and high rotation low torque in which the torque becomes relatively high at low rotation and relatively low at high rotation. For this reason, in the regenerative state, when the motor rotates at a low speed, sudden deceleration not intended by the driver may occur, and the driver may be induced to re-accelerate or the load may collapse.

Note that in the technique described in Patent Literature 2, the torque rate is changed depending on whether or not a target torque is increased, but the torque rate is not changed based on the accelerator opening degree, and thus the above-described problem cannot be solved.

Therefore, an object of the present disclosure is to provide an electric vehicle control device capable of appropriately reflecting the will of a driver regarding acceleration/deceleration of an electric vehicle accompanying an operation of the driver.

### Solution to Problem

An electric vehicle control device of the present disclosure is as follows.

[1] An electric vehicle 1 device that controls acceleration/deceleration of an electric vehicle using a motor as a drive source, the electric vehicle control device including: an accelerator opening degree detection unit configured to detect an accelerator opening of the electric vehicle; a motor rotation speed detection unit configured to detect a motor rotation speed; and a motor control unit configured to control the motor, in which the motor control unit obtains a target torque based on the accelerator opening degree and the motor rotation speed, obtains a torque rate that is an amount of change in torque per unit time based on the accelerator opening degree, and controls the motor such that a torque of the motor becomes the target torque at the torque rate.

In this electric vehicle control device, since the torque rate can be changed based on the accelerator opening degree that is an operation of a driver, it is possible to appropriately reflect the will of the driver regarding the acceleration/deceleration of the electric vehicle accompanying the operation of the driver.

[2] The electric vehicle control device according to [1], in which the motor control unit obtains the torque rate also based on the motor rotation speed.

In this electric vehicle control device, the torque rate is obtained based on the accelerator opening degree and the motor rotation speed, so that the torque rate can be changed in consideration of the influence of travel resistance or the like that changes depending on a vehicle speed. As a result, for example, a good driving feeling can be given to the driver for each speed range of the vehicle speed.

[3] The electric vehicle control device according to [1] or [2], further including a current torque detection unit configured to detect a current torque generated by the motor, in which in a power running state in which the target torque is larger than the current torque, the motor control unit makes the torque rate in a case where the accelerator opening degree falls below a threshold opening degree smaller than the torque rate in a case where the accelerator opening degree exceeds the threshold opening degree.

In this electric vehicle control device, in the power running state, the torque rate in the case where the accelerator opening degree falls below the threshold opening degree is made smaller than the torque rate in the case where the accelerator opening degree exceeds the threshold opening degree. As a result, in a case where the accelerator opening degree is small, the torque rate becomes small, so that it is possible to reflect the will of the driver to slowly accelerate the electric vehicle. On the other hand, in a case where the accelerator opening degree is large, the torque rate becomes large, so that it is possible to reflect the will of the driver to immediately accelerate the electric vehicle.

[4] The electric vehicle control device according to [3], in which in a regenerative state in which the target torque is smaller than the current torque, the motor control unit makes the torque rate in a case where the current torque falls below a threshold torque smaller than the torque rate in a case where the current torque exceeds the threshold torque.

In this electric vehicle control device, in the regenerative state, the torque rate in the case where the current torque falls below the threshold torque is made smaller than the torque rate in the case where the current torque exceeds the threshold torque. As a result, in a case where the current torque is at low rotation as in a case where the motor rotates at a low speed, it is possible to suppress occurrence of sudden deceleration not intended by the driver. As a result, it is possible to prevent the driver from inducing re-acceleration or the cargo from collapsing. On the other hand, in a case where the current torque is small, it is possible to suppress a decrease in the regeneration amount of the motor.

[5] The electric vehicle control device according to [4], in which the motor control unit makes the torque rate in the regenerative state smaller than the torque rate in the power running state under a condition where the accelerator opening degrees are the same.

In this electric vehicle control device, by making the torque rate in the regenerative state smaller than the torque rate in the power running state, the deceleration of the electric vehicle becomes gentle, and the driver can easily adjust to target deceleration.

### Advantageous Effects of Invention

According to the present disclosure, it is possible to appropriately reflect the will of a driver regarding acceleration/deceleration of an electric vehicle accompanying an operation of the driver.

### BRIEF DESCRIPTION OF DRAWINGS

FIG. 1 is a block configuration diagram illustrating an electric vehicle control device according to an embodiment.

FIG. 2 is a graph illustrating an example of a relationship among an accelerator opening degree, a motor rotation speed, and a torque of a motor.

FIG. 3 is a diagram corresponding to FIG. 2 for explaining a torque rate in each state.

FIG. 4 is a flowchart illustrating an example of a processing operation of the electric vehicle control device.

### DESCRIPTION OF EMBODIMENTS

Hereinafter, embodiments of the present disclosure will be described in detail with reference to the drawings. Note that in the following description, the same or corresponding elements are denoted by the same reference numerals, and redundant description is omitted.

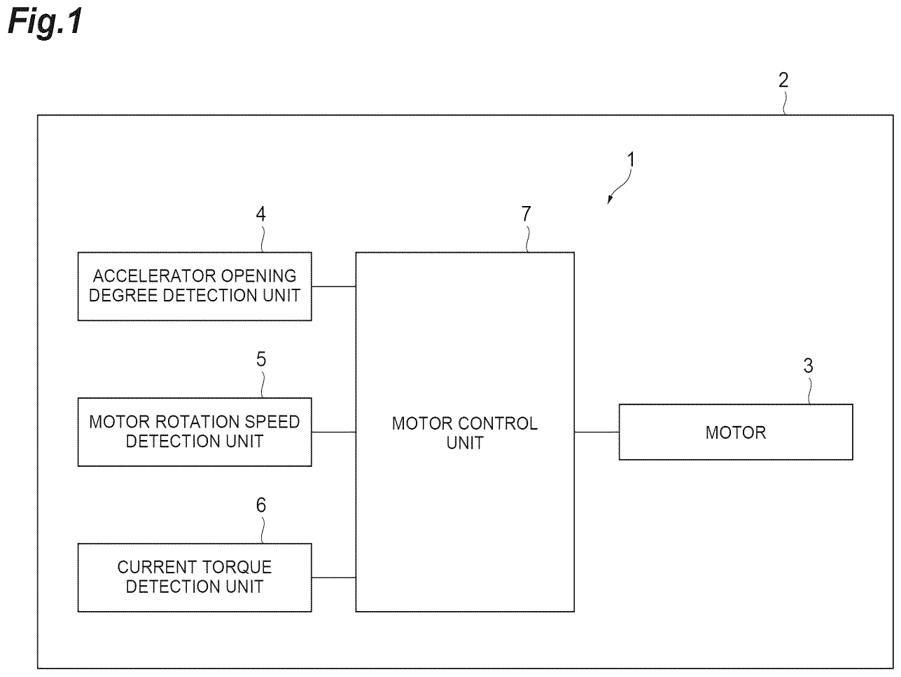

FIG. 1 is a block configuration diagram illustrating an electric vehicle control device 1 according to an embodiment. As illustrated in FIG. 1, the electric vehicle control device 1 according to the present embodiment is mounted on an electric vehicle 2 using a motor 3 as a drive source, and controls acceleration/deceleration of the electric vehicle 2. Examples of the electric vehicle 2 include a hybrid electric vehicle (HEV), a plug-in hybrid electric vehicle (PHEV), a fuel cell electric vehicle (FCEV), and a battery electric vehicle (BEV). The electric vehicle control device 1 controls the motor 3 as control of the acceleration/deceleration of the electric vehicle 2.

The motor 3 is a motor generator (motor generator) that functions as an electric motor or a generator. The motor 3 functions as an electric motor and drives the electric vehicle 2 by generating a power running torque that is a positive torque. On the other hand, the motor 3 functions as a generator and charges a battery (not illustrated) by generating a regenerative torque that is a negative torque.

The electric vehicle control device 1 includes an accelerator opening degree detection unit 4, a motor rotation speed detection unit 5, a current torque detection unit 6, and a motor control unit 7.

The accelerator opening degree detection unit 4 detects an accelerator opening degree of the electric vehicle 2, which is an operation amount of a driver. As the accelerator opening degree detection unit 4, for example, an accelerator opening degree sensor that detects an accelerator opening degree of an accelerator pedal can be used. The accelerator opening degree detection unit 4 transmits a detection signal of the detected accelerator opening degree to the motor control unit 7.

The motor rotation speed detection unit 5 detects a motor rotation speed that is a rotation speed of the motor 3. As the motor rotation speed detection unit 5, for example, a rotation speed sensor such as a rotary encoder that detects the rotation speed of the motor 3 can be used. Here, in the electric vehicle 2, the motor rotation speed and a vehicle speed of the electric vehicle 2 are in a proportional relationship. Therefore, the motor rotation speed can be converted into the vehicle speed of the electric vehicle 2. The motor rotation speed detection unit 5 transmits a detection signal of the detected motor rotation speed to the motor control unit 7.

The current torque detection unit 6 detects a current torque that is a torque generated by the motor 3. As the current torque detection unit 6, for example, a torque sensor or the like that detects the torque of the motor 3 can be used. The current torque detection unit 6 transmits a detection signal of the detected current torque to the motor control unit 7.

The motor control unit 7 is, for example, an electronic control unit (ECU) including a central processing unit (CPU), a read only memory (ROM), and a random access memory (RAM). In the motor control unit 7, for example, a program stored in the ROM is loaded into the RAM and executed by the CPU to execute various controls. The motor control unit 7 may be configured by a single electronic control unit or may be configured by a plurality of electronic control units.

The motor control unit 7 acquires the accelerator opening degree detected by the accelerator opening degree detection unit 4, the motor rotation speed detected by the motor rotation speed detection unit 5, and the current torque detected by the current torque detection unit 6. Then, the motor control unit 7 controls the motor 3 based on the acquired accelerator opening degree, motor rotation speed, and current torque. Examples of the control of the motor 3 include power running control for causing the motor 3 to generate the power running torque that is a positive torque and regenerative control for causing the motor 3 to generate the regenerative torque that is a negative torque.

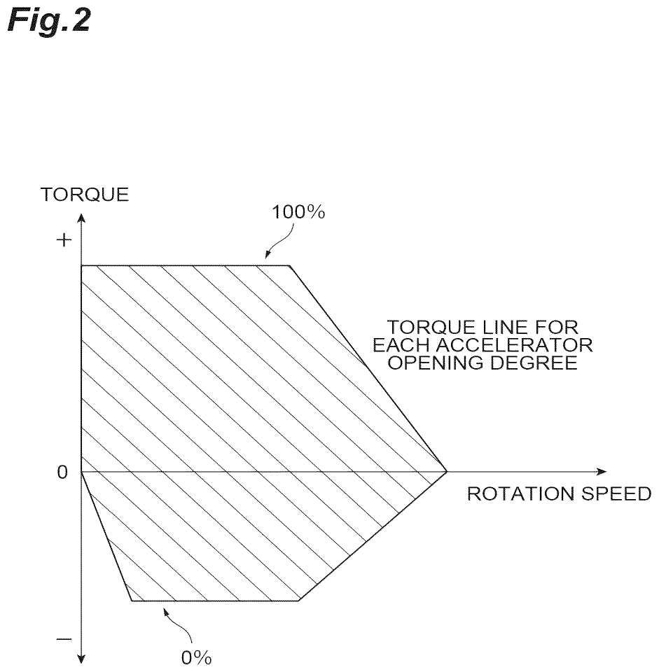

The motor control unit 7 obtains a target torque to be generated by the motor 3 based on the accelerator opening degree and the motor rotation speed. FIG. 2 is a graph illustrating an example of a relationship among the accelerator opening degree, the motor rotation speed, and the torque of the motor. In FIG. 2, the vertical axis represents the torque of the motor, and the vertical axis represents the motor rotation speed. In addition, in FIG. 2, the torque on the positive side of zero indicates the positive torque, that is, the power running torque, and the torque on the negative side of zero indicates the negative torque, that is, the regenerative torque. As illustrated in FIG. 2, an outputtable torque according to the motor rotation speed is determined for the motor 3. Therefore, the motor control unit 7 obtains the target torque based on the accelerator opening degree and the motor rotation speed within the range of the outputtable torque according to the motor rotation speed. For example, the motor control unit 7 may obtain the target torque based on the accelerator opening degree and the motor rotation speed by referring to a table (governor table) in which the accelerator opening degree, the motor rotation speed, and the target torque are associated with each other. The governor table may be, for example, a table in which the target torque corresponding to each motor rotation speed and each accelerator opening degree is represented in a two-dimensional matrix with the motor rotation speed as a horizontal axis and the accelerator opening degree as a vertical axis.

Here, in a case where the target torque is larger than the current torque, it is necessary to perform power running control to raise the torque of the motor 3 in order to cause the motor 3 to generate the target torque. Therefore, a state in which the target torque is larger than the current torque is referred to as a power running state. On the other hand, in a case where the target torque is smaller than the current torque, it is necessary to perform regenerative control to lower the torque of the motor 3 in order to cause the motor 3 to generate the target torque. Therefore, a state in which the target torque is smaller than the current torque is referred to as a regenerative state.

After obtaining the target torque, the motor control unit 7 obtains, based on the accelerator opening degree, a torque rate (Nm/sec) that is the amount of change in torque per unit time. In other words, the motor control unit 7 changes the torque rate based on the accelerator opening degree. The torque rate is not a fixed value but a variable value that is changed based on the accelerator opening degree. When the torque rate increases, the amount of change in torque per unit time increases. Therefore, in the power running control, the amount of increase in torque per unit time increases, and in the regenerative control, the amount of decrease in torque per unit time increases. On the other hand, when the torque rate decreases, the amount of change in torque per unit time decreases. Therefore, in the power running control, the amount of increase in torque per unit time decreases, and in the regenerative control, the amount of decrease in torque per unit time decreases.

Here, since the power running control for raising the torque of the motor 3 is performed in the power running state, the torque rate in the power running state is referred to as a torque rise rate. The torque rise rate is the amount of increase in torque per unit time. On the other hand, since the regenerative control for lowering the torque of the motor 3 is performed in the regenerative state, the torque rate in the regenerative state is referred to as a torque lowering rate. The torque lowering rate is the amount of decrease in torque per unit time.

In the power running state, the motor control unit 7 obtains (changes) the torque rise rate based on the accelerator opening degree and the motor rotation speed. More specifically, the motor control unit 7 makes the torque rise rate in a case where the accelerator opening degree falls below a threshold opening degree smaller than the torque rise rate in a case where the accelerator opening degree exceeds the threshold opening degree. That is, under a condition where the motor rotation speeds are the same, the motor control unit 7 makes the torque rise rate in the case where the accelerator opening degree falls below the threshold opening degree lower than the torque rise rate in the case where the accelerator opening degree exceeds the threshold opening degree. In addition, the motor control unit 7 obtains (changes) the torque rise rate in the case where the accelerator opening degree falls below the threshold opening degree and the torque rise rate in the case where the accelerator opening degree exceeds the threshold opening degree according to the motor rotation speed. Note that when the motor rotation speeds are different from each other, the torque rise rate in the case where the accelerator opening degree falls below the threshold opening degree may be smaller than the torque rise rate in the case where the accelerator opening degree exceeds the threshold opening degree. The threshold opening degree is not particularly limited, but may be, for example, a half accelerator (50%). For example, when the motor rotation speed is 1000 rpm and the threshold opening degree is 50%, the torque rise rate at which the accelerator opening degree is 40% is made smaller than the torque rise rate at which the accelerator opening degree is 60%. In addition, the torque rise rate may be a plurality of values (variable values) according to the accelerator opening degree in each of the case where the accelerator opening degree exceeds the threshold opening degree and the case where the accelerator opening degree falls below the threshold opening degree.

For example, the motor control unit 7 may obtain the torque rise rate based on the accelerator opening degree and the motor rotation speed by referring to a table (torque rise rate table) in which the accelerator opening degree, the motor rotation speed, and the torque rise rate are associated with each other. The torque rise rate table may be, for example, a table in which the torque rise rate corresponding to each accelerator opening degree and each motor rotation speed is represented in a two-dimensional matrix with the motor rotation speed as a horizontal axis and the accelerator opening as a vertical axis.

In the regenerative state, the motor control unit 7 obtains (changes) the torque lowering rate based on the current torque of the motor 3 and the motor rotation speed. More specifically, the motor control unit 7 makes the torque lowering rate in a case where the current torque falls below a threshold torque smaller than the torque lowering rate in a case where the current torque exceeds the threshold torque. That is, under the condition where the motor rotation speeds are the same, the motor control unit 7 makes the torque lowering rate in the case where the current torque falls below the threshold torque smaller than the torque lowering rate in the case where the current torque exceeds the threshold torque. In addition, the motor control unit 7 obtains (changes) the torque lowering rate in the case where the current torque falls below the threshold torque and the torque lowering rate in the case where the current torque exceeds the threshold torque according to the motor rotation speed. Note that when the motor rotation speeds are different from each other, the torque lowering rate in the case where the current torque falls below the threshold torque may not be made smaller than the torque lowering rate in the case where the current torque exceeds the threshold torque. The threshold torque is not particularly limited.

For example, the motor control unit 7 may obtain the torque lowering rate based on the current torque of the motor 3 and the motor rotation speed by referring to a table (torque lowering rate table) in which the current torque, the motor rotation speed, and the torque lowering rate are associated with each other. The torque lowering rate table may be, for example, a table in which the torque lowering rate corresponding to each current torque and each motor rotation speed is represented in a two-dimensional matrix with the motor rotation speed as a horizontal axis and the current torque as a vertical axis.

In addition, under a condition where the accelerator opening degrees are the same, the motor control unit 7 makes the torque lowering rate in the regenerative state smaller than the torque rise rate in the power running state. Note that when the accelerator opening degrees are different, the torque lowering rate in the regenerative state may not be made smaller than the torque rise rate in the power running state.

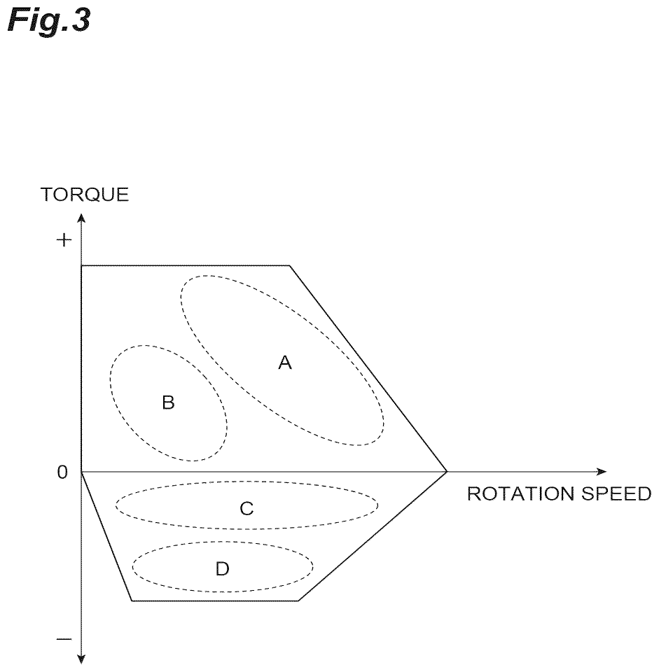

Here, the torque rate in each of the above states will be described with reference to FIG. 3. FIG. 3 is a diagram corresponding to FIG. 2 for explaining the torque rate in each state. As illustrated in FIG. 3, a state in which the accelerator opening degree exceeds the threshold opening degree in the power running state is referred to as a power-running high-opening-degree state A, and a state in which the accelerator opening degree falls below the threshold opening degree in the power running state is referred to as a power-running low-opening-degree state B. In the power-running high-opening-degree state A, since it is considered that the driver is pressing down on an accelerator based on an intention to immediately accelerate the electric vehicle 2, the torque rise rate is increased. That is, the amount of increase in torque per unit time is increased. On the other hand, in the power-running low-opening-degree state B, since it is considered that the driver is pressing down on the accelerator based on an intention to slowly accelerate the electric vehicle 2, the torque rise rate is made smaller than that in the power-running high-opening-degree state A. That is, the amount of increase in torque per unit time is made smaller than that in the power-running high-opening-degree state A.

In addition, a state in which the current torque falls below the threshold torque in the regenerative state is referred to as a regenerative low torque state C, and a state in which the current torque exceeds the threshold torque in the regenerative state is referred to as a regenerative high torque state D. In the regenerative high torque state D, the torque lowering rate is decreased in order to suppress the occurrence of sudden deceleration unintended by the driver. That is, the amount of decrease in torque per unit time is decreased. On the other hand, in the regenerative low torque state C, the torque lowering rate is made larger than that in the regenerative high torque state D in order to suppress a decrease in the regeneration amount of the motor 3. That is, the amount of decrease in torque per unit time is made larger than that in the regenerative high torque state D.

Then, in the regenerative state, when the torque rate is large, it is difficult to adjust to target deceleration as compared with the power running state. Therefore, under the condition where the accelerator opening degrees are the same, the torque rates (torque lowering rates) in the regenerative low torque state C and the regenerative high torque state D are made smaller than the torque rates (torque rise rates) in the power-running high-opening-degree state A and the power-running low-opening-degree state B. More specifically, under the condition where the motor rotation speeds are the same, the torque rate is decreased in the order of the power-running high-opening-degree state A, the power-running low-opening-degree state B, the regenerative low torque state C, and the regenerative high torque state D. Note that since the torque rise rate and the torque lowering rate are opposite in positive and negative, decreasing the torque rate means decreasing the absolute value of the torque rate.

As illustrated in FIG. 1, when obtaining the torque rate, the motor control unit 7 controls the motor 3 such that the torque of the motor 3 becomes the target torque at the obtained torque rate. Specifically, the motor control unit 7 calculates a torque obtained by adding the torque rate to the current torque as an instruction torque. Then, in a case where the instruction torque is smaller than the target torque, the motor control unit 7 controls the motor 3 with the instruction torque. On the other hand, in a case where the instruction torque is larger than or equal to the target torque, the motor control unit 7 controls the motor 3 with the target torque.

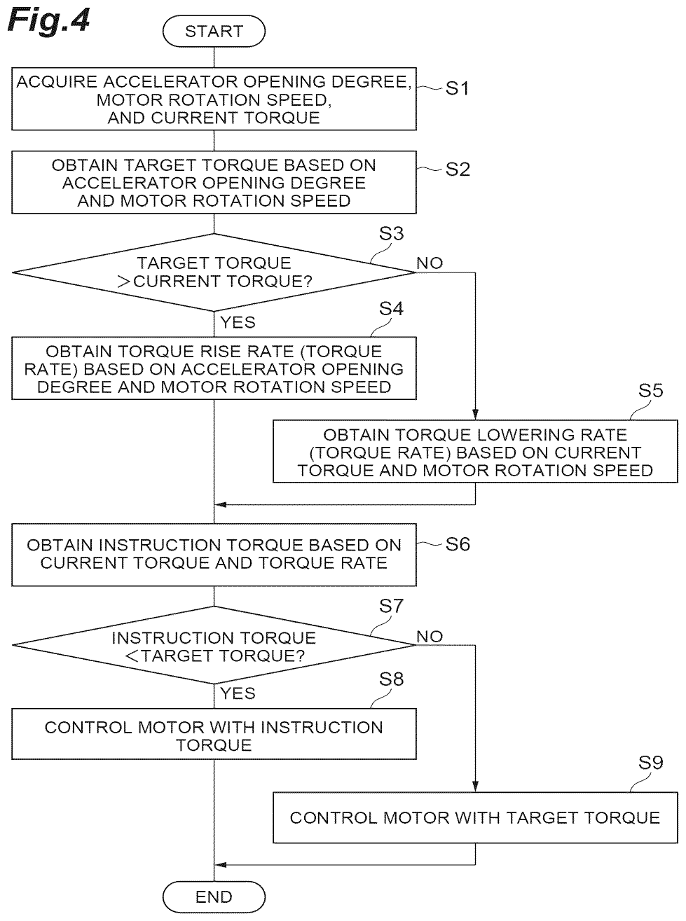

Next, an example of a processing operation of the electric vehicle control device 1 will be described with reference to FIG. 4. FIG. 4 is a flowchart illustrating the example of the processing operation of the electric vehicle control device.

As illustrated in FIG. 4, first, the electric vehicle control device 1, the accelerator opening degree, the motor rotation speed, and the current torque are acquired (step S1). The accelerator opening degree is acquired from the accelerator opening degree detection unit 4, the motor rotation speed is acquired from the motor rotation speed detection unit 5, and the current torque is acquired from the current torque detection unit 6. Next, the electric vehicle control device 1 obtains a target torque based on the accelerator opening degree and the motor rotation speed acquired in step S1 (step S2). The target torque is obtained, for example, by referring to the governor map. Next, the electric vehicle control device 1 determines whether or not the target torque obtained in step S2 is larger than the current torque acquired in step S1 (step S3).

In a case where it is determined that the target torque is larger than the current torque (step S3: YES), the electric vehicle control device 1 determines that the state is the power running state, and obtains the torque rise rate (torque rate) based on the accelerator opening degree and the motor rotation speed acquired in step S1 (step S4). In step S4, the electric vehicle control device 1 refers to the torque rise rate table or the like to obtain the torque rise rate such that the torque rise rate in the case where the accelerator opening degree falls below the threshold opening degree is smaller than the torque rise rate in the case where the accelerator opening degree exceeds the threshold opening degree.

On the other hand, in a case where it is determined that the target torque is not larger than the current torque (step S3: NO), the electric vehicle control device 1 determines that the state is the regenerative state, and obtains the torque lowering rate (torque rate) based on the current torque and the motor rotation speed acquired in step S1 (step S5). In step S5, the electric vehicle control device 1 refers to the torque lowering rate table or the like to obtain the torque lowering rate such that the torque lowering rate in the case where the current torque falls below the threshold torque is smaller than the torque lowering rate in the case where the current torque exceeds the threshold torque. In addition, the electric vehicle control device 1 obtains the torque lowering rate such that the torque lowering rate becomes a torque rate smaller than the torque rise rate obtained in the case where it is determined that the target torque is larger than the current torque (step S3: YES) by referring to the torque lowering rate table or the like.

Then, the electric vehicle control device 1 obtains the instruction torque based on the current torque acquired in step S1 and the torque rise rate (torque rate) obtained in step S4 or the torque lowering rate (torque rate) obtained in step S5 (step S6). In step S6, the electric vehicle control device 1 obtains the instruction torque by adding the obtained torque rise rate or torque lowering rate to the current torque. Next, the electric vehicle control device 1 determines whether or not the instruction torque obtained in step S6 is smaller than the target torque obtained in step S2 (step S7).

When it is determined that the instruction torque is smaller than the target torque (step S7: YES), the electric vehicle control device 1 controls the motor 3 with the instruction torque obtained in step S6 (step S8). Then, the electric vehicle control device 1 temporarily ends the processing and repeats the processing from step S1 again.

On the other hand, when it is determined that the instruction torque is not smaller than the target torque (step S7: NO), the electric vehicle control device 1 controls the motor 3 with the target torque obtained in step S2 (step S9). Then, the electric vehicle control device 1 temporarily ends the processing and repeats the processing from step S1 again.

As described above, in the electric vehicle control device 1 according to the present embodiment, since the torque rate can be changed based on the accelerator opening degree that is the operation of the driver, it is possible to appropriately reflect the will of the driver regarding the acceleration/deceleration of the electric vehicle 2 accompanying the operation of the driver.

In addition, in the electric vehicle control device 1, the torque rate is obtained based on the accelerator opening degree and the motor rotation speed, so that the torque rate can be changed in consideration of the influence of travel resistance or the like that changes depending on the vehicle speed. As a result, for example, a good driving feeling can be given to the driver for each speed range of the vehicle speed.

In addition, in the electric vehicle control device 1, in the power running state, the torque rate in the case where the accelerator opening degree falls below the threshold opening degree is made smaller than the torque rate in the case where the accelerator opening degree exceeds the threshold opening degree. As a result, in a case where the accelerator opening degree is small, the torque rate becomes small, so that it is possible to reflect the will of the driver to slowly accelerate the electric vehicle 2. On the other hand, in a case where the accelerator opening degree is large, the torque rate becomes large, so that it is possible to reflect the will of the driver to immediately accelerate the electric vehicle.

In addition, in the electric vehicle control device 1, in the regenerative state, the torque rate in the case where the current torque falls below the threshold torque is made smaller than the torque rate in the case where the current torque exceeds the threshold torque. As a result, it is possible to suppress occurrence of sudden deceleration not intended by the driver in a case where the current torque is large. As a result, it is possible to prevent the driver from inducing re-acceleration or the cargo from collapsing. On the other hand, in a case where the current torque is small, it is possible to suppress a decrease in the regeneration amount of the motor 3.

In addition, in the electric vehicle control device 1, by making the torque rate in the regenerative state smaller than the torque rate in the power running state, the deceleration of the electric vehicle 2 becomes gentle and the driver can easily adjust to the target deceleration.

Although the embodiment of the present disclosure has been described above, the present disclosure is not limited to the above embodiment, and may be modified or applied to other things without changing the gist described in each claim.

For example, in the above embodiment, it has been described that the torque rise rate is changed based on the accelerator opening degree and the motor rotation speed. However, the torque rise rate is changed based on the accelerator opening degree, but may not be changed based on the motor rotation speed.

In addition, in the above embodiment, it has been described that both the torque rise rate and the torque lowering rate are changed as the torque rate, but only the torque rise rate may be changed.

### REFERENCE SIGNS LIST

1 ELECTRIC VEHICLE CONTROL DEVICE
2 ELECTRIC VEHICLE
3 MOTOR
4 ACCELERATOR OPENING DEGREE DETECTION UNIT
5 MOTOR ROTATION SPEED DETECTION UNIT
6 TORQUE DETECTION UNIT
7 MOTOR CONTROL UNIT
A POWER-RUNNING HIGH-OPENING-DEGREE STATE
B POWER-RUNNING LOW-OPENING-DEGREE STATE
C REGENERATIVE LOW TORQUE STATE
D REGENERATIVE HIGH TORQUE STATE

1. An electric vehicle control device that controls acceleration/deceleration of an electric vehicle using a motor as a drive source, the electric vehicle control device comprising:
an accelerator opening degree detection unit configured to detect an accelerator opening degree of the electric vehicle;
a motor rotation speed detection unit configured to detect a motor rotation speed; and
a motor control unit configured to control the motor, wherein
the motor control unit
obtains a target torque based on the accelerator opening degree and the motor rotation speed,
obtains a torque rate that is an amount of change in torque per unit time based on the accelerator opening degree, and
controls the motor such that a torque of the motor becomes the target torque at the torque rate.

2. The electric vehicle control device according to claim 1, wherein
the motor control unit obtains the torque rate also based on the motor rotation speed.

3. The electric vehicle control device according to claim 1, further comprising
a current torque detection unit configured to detect a current torque generated by the motor, wherein
in a power running state in which the target torque is larger than the current torque, the motor control unit makes the torque rate in a case where the accelerator opening degree falls below a threshold opening degree smaller than the torque rate in a case where the accelerator opening degree exceeds the threshold opening degree.

4. The electric vehicle control device according to claim 3, wherein
in a regenerative state in which the target torque is smaller than the current torque, the motor control unit makes the torque rate in a case where the current torque falls below a threshold torque smaller than the torque rate in a case where the current torque exceeds the threshold torque.

5. The electric vehicle control device according to claim 4, wherein
the motor control unit makes the torque rate in the regenerative state smaller than the torque rate in the power running state under a condition where the accelerator opening degrees are the same.
